(19) United States
(12) Patent Application Publication
(10) Pub. No.: US 2025/0243631 A1
(43) Pub. Date: Jul. 31, 2025

(54) ASPHALT COMPOSITION

(71) Applicant: KAO CORPORATION, Tokyo (JP)

(72) Inventors: Shogo KAMENOUE, Wakayama-shi, Wakayama (JP); Yusuke AKINO, Wakayama-shi, Wakayama (JP)

(73) Assignee: KAO CORPORATION, Tokyo (JP)

(21) Appl. No.: 18/855,060

(22) PCT Filed: Apr. 10, 2023
(86) PCT No.: PCT/JP2023/014618

§ 371 Date: Oct. 8, 2024

(30) Foreign Application Priority Data
Apr. 11, 2022 (JP) 2022-065295

(51) Int. Cl. E01C 7/26; C08L 95/00; E01C 19/10

(52) U.S. Cl. CPC E01C 7/265; C08L 95/00; E01C 19/1009

(57) ABSTRACT

The present invention relates to an asphalt composition containing an asphalt, a polyester resin, and a crosslinked rubber.

### FIELD OF THE INVENTION

The present invention relates to an asphalt composition, an asphalt mixture and a method for producing thereof, and a road pavement method.

### BACKGROUND OF THE INVENTION

Asphalt pavement using an asphalt mixture is applicated since it is relatively easy to construct for paving automobile roads, parking, freight yards, sidewalks, etc., and it takes short time from the start of paving work to the start of traffic. In this asphalt pavement, the paved roads have good hardness and durability since the road surface is formed from an asphalt mixture in which an aggregate is bonded with an asphalt.

However, an asphalt pavement surface deteriorates by long-term use, and it becomes necessary to repair the pavement. By repairing the pavement, the maintenance cost increased and it has resulted in a significant impact on automobile traffic.

Furthermore, tires for automobiles need to be replaced regularly, and a large amount of waste tires are generated. Waste tires are recycled by use as fuel for thermal recycling as tire chips and cut tires, and by use as materials such as rubber powder, rubber chips, and elastic materials. However, since the demand as a fuel is rapidly decreasing, it is becoming difficult to maintain resource recycling.

Conventionally, it has been known that rubber powder derived from waste tires, etc., was added to an asphalt to obtain an asphalt rubber, and was used as an asphalt binder for pavement. In addition, from the aspect of effective use of waste, it also has been known that a rubber and/or a thermoplastic elastomer, rubber waste, waste tires, a sulfur-containing resin, etc., are added to an asphalt, and aggregates such as gravel and crushed stone are mixed with this to perform pavement construction.

WO2021/177443 (PTL 1) discloses an asphalt composition containing an asphalt, a polyethylene terephthalate, and a polyester which is a polycondensate of a specific alcohol and a carboxylic acid compound, as an asphalt composition which has excellent storage stability and can suppress rutting on the pavement surface after construction.

In JP2017-155233A (PTL 2), an asphalt composition containing a repeating unit of a specific structure, an additive in which at least one of the terminal groups is a specific structure, and an asphalt, is disclosed as an asphalt composition which uses a highly functional asphalt additive which is excellent for mixing the asphalt and the aggregate, can improve the compaction properties and moisture resistance of asphalt mixtures and provide asphalt with excellent mechanical properties such as marshall stability and dynamic stability.

### SUMMARY OF THE INVENTION

The present invention relates to the following items [1] to [4].

[1] An asphalt composition containing an asphalt, a polyester resin, and a crosslinked rubber.

[2] An asphalt mixture containing an asphalt, a polyester resin, a crosslinked rubber, and an aggregate.

[3] A method for producing an asphalt mixture containing a step of mixing an asphalt, a polyester resin, a heated aggregate, and a crosslinked rubber.

[4] A road pavement method containing a step of constructing the asphalt mixture according to the above item [2] or the asphalt mixture obtained by the method according to the above items [3], and forming an asphalt pavement material layer.

### DETAILED DESCRIPTION OF THE INVENTION

According to the art of the PTL 1, an asphalt pavement having excellent durability is provided. However, the flexibility may be insufficient and the cracking resistance may be insufficient, therefore there was room for further improvement.

In the PTL 2, polymeric modifiers such as recycled rubber of waste tires are disclosed, however the asphalt pavements containing rubber components tend to have poor durability. Furthermore, PTL 2 discloses polyester fibers as one type of fillers. However, polyester fibers have good effect as fillers since they are usually stretched and oriented, and the softening point is high, however the modification effect of asphalt may be insufficient.

The present invention relates to an asphalt composition which can exhibit the modification effect of polyester resins to maximum, and can form the pavement surface having excellent durability and flexibility, an asphalt mixture and a method for producing thereof, and a road pavement method.

According to the present invention, an asphalt composition which can form the pavement surface having excellent durability and flexibility, an asphalt mixture and a method for producing thereof, and a road pavement method can be provided.

In particular, when the crosslinked rubber is derived from waste tires, it can provide a new art which complements the resource recycling of tires.

### EMBODIMENTS

### [Asphalt Composition]

An asphalt composition contains an asphalt, a polyester resin, and a crosslinked rubber.

The inventors found that by mixing a crosslinked rubber into an asphalt composition with a polyester resin, the asphalt composition which can form a pavement surface having excellent durability and flexibility can be obtained.

The detailed mechanism by which the effects of the present invention are obtained is unknown, a part of it is considered to be as follows.

It is considered that by combining a polyester resin and a crosslinked rubber, viscoelasticity which cannot be exhibited by the crosslinked rubber alone in asphalt is exhibited, thereby imparting durability and flexibility to an asphalt pavement at the same time.

Definitions and the like of various terms used in this description are shown below.

“Binder mixture” means a mixture containing an asphalt and a thermoplastic elastomer, and is a concept that includes, for example, an asphalt modified with a thermoplastic elastomer, etc. (hereinafter also referred to as “modified asphalt”) described below).

In the polyester resin, a “constituent unit derived from an alcohol component” means a structure in which a hydrogen atom is removed from a hydroxy group of the alcohol component, and a “constituent unit derived from a carboxylic acid component” means a structure in which a hydroxy group is removed from a carboxy group of the carboxylic acid component.

“Carboxylic acid component” is a concept which includes not only the carboxylic acid, but also anhydrides which decompose during the reaction to produce acids, and alkyl esters of carboxylic acids (for example, 1 or more and 3 or less carbon number of alkyl groups). When the carboxy acid component is an alkyl ester of carboxylic acid, the carbon number of the alkyl group that is the alcohol residue of the ester is not included in the number of carbon atoms of the carboxylic acid.

### <Asphalt>

Various asphalts can be used as the asphalt. Examples include straight asphalt, which is petroleum asphalt for paving, and modified asphalt. Examples of the modified asphalt include blown asphalt; polymer-modified asphalt modified with polymer materials such as thermoplastic elastomers and thermoplastic resins. Straight asphalt is a residual bituminous substance obtained by subjecting crude oil to atmospheric distillation equipment, vacuum distillation equipment, etc. Moreover, blown asphalt means asphalt obtained by heating a mixture of straight asphalt and heavy oil, and then blowing air and oxidizing it. The asphalt is preferably selected from straight asphalt and polymer-modified asphalt, and polymer-modified asphalt is more preferred from the viewpoint of durability of asphalt pavement, and straight asphalt is more preferred from the viewpoint of versatility. As the polymer-modified asphalt, asphalt modified with a thermoplastic elastomer is more preferred.

The modified asphalt is preferably a polymer-modified asphalt, more preferably a polymer-modified asphalt modified with a thermoplastic elastomer.

### (Thermoplastic Elastomer)

As the thermoplastic elastomer in polymer-modified asphalt modified with a thermoplastic elastomer, for example, examples include at least one selected from styrene/butadiene block copolymer, styrene/butadiene/styrene block copolymer, styrene/butadiene random copolymer, styrene/isoprene block copolymer, styrene/isoprene/styrene block copolymer, styrene/isoprene random copolymer, ethylene/vinyl acetate copolymer, ethylene/acrylic acid ester copolymer, styrene/ethylene/butylene/styrene copolymer, styrene/ethylene/propylene/styrene copolymer, polyurethane-based thermoplastic elastomer, polyolefin-based thermoplastic plastic elastomer, isobutylene/isoprene copolymer, polyisoprene, polychloroprene, synthetic rubber other than the above, and natural rubber. The thermoplastic elastomer in the modified asphalt is preferably at least one selected from styrene/butadiene block copolymer, styrene/butadiene/styrene block copolymer, styrene/butadiene random copolymer, styrene/isoprene block copolymer, styrene/isoprene/styrene block copolymer, styrene/isoprene random copolymer, ethylene/vinyl acetate copolymer, and ethylene/acrylic acid ester copolymer.

Among these thermoplastic elastomers, from the viewpoint of rutting resistance of asphalt pavement, at least one selected from styrene/butadiene block copolymer, styrene/butadiene/styrene block copolymer, styrene/butadiene random copolymer, styrene/isoprene block copolymer, styrene/isoprene/styrene block copolymer, styrene/isoprene random copolymer, and ethylene/acrylic acid ester copolymers is preferred; at least one selected from styrene/butadiene block copolymer, styrene/butadiene/styrene block copolymer, styrene/butadiene random copolymer, styrene/isoprene block copolymer, styrene/isoprene/styrene block copolymer, and styrene/isoprene random copolymers is more preferred; at least one selected from styrene/butadiene random copolymer, and styrene/butadiene/styrene block copolymers is further more preferred.

The content of the thermoplastic elastomer in the polymer-modified asphalt is, from the viewpoint of rutting resistance and surface aesthetic appearance of asphalt pavement, preferably 0.1 mass % or more, more preferably 0.5 mass % or more, and further more preferably 1 mass % or more, and preferably 30 mass % or less, more preferably 20 mass % or less, further more preferably 10 mass % or less.

### <Polyester Resin>

The polyester resin contained in the asphalt composition of the present invention is a polycondensate of an alcohol component and a carboxylic acid component, containing a constituent unit derived from an alcohol component and a constituent unit derived from a carboxylic acid component.

Examples of the polyester resin include amorphous polyester resins and crystalline polyester resins, and amorphous polyester resins are preferred.

The physical properties of the alcohol component, the carboxylic acid component, and the polyester resin will be explained below.

### (Alcohol Component)

Examples of the alcohol component include chain aliphatic diols, alicyclic diols, aromatic diols, polyhydric alcohols having 3 or more hydroxy groups. These alcohol components may be used alone or in combination of two or more.

As the chain aliphatic diol, a linear or branched chain aliphatic diol having a carbon number of 2 or more and 12 or less in the main chain is preferred, a linear or branched chain aliphatic diol having a carbon number of 2 or more and 8 or less in the main chain is more preferred.

Further, the chain aliphatic diol is preferably a saturated chain aliphatic diol.

Specific examples of the chain aliphatic diols include ethylene glycol, 1,2-propanediol, 1,3-propanediol, 1,3-butanediol, 1,4-butanediol, 1,4-butenediol, 1,5-pentanediol, 1,6-hexanediol, neopentyl glycol, 1,10-decanediol, and 1,12-dodecanediol.

Examples of the alicyclic diol include hydrogenated bisphenol A (2,2-bis(4-hydroxycyclohexyl) propane), an alkylene oxide adduct of hydrogenated bisphenol A, cyclohexanediol, and cyclohexanedimethanol.

Examples of the aromatic diol include bisphenol A (2,2-bis(4-hydroxyphenyl) propane) and an alkylene oxide adduct of bisphenol A. Examples of the alkylene oxide adducts of bisphenol A include an alkylene oxide adduct of bisphenol A represented by the following formula (I).

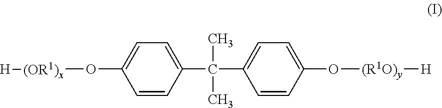

[In the formula, OR¹ and R¹O are alkylene oxides, R¹ is an alkylene group having a carbon number of 2 or 3, x and y are positive numbers indicating the average number of moles of alkylene oxide added, and the sum of x and y is preferably 1 or more, more preferably 1.5 or more, and preferably 16 or less, more preferably 8 or less, further more preferably 4 or less].

Examples of the alkylene oxide adduct of bisphenol A represented by the formula (I) include a propylene oxide adduct of bisphenol A and an ethylene oxide adduct of bisphenol A. These alkylene oxide adducts of bisphenol A may be used alone or in combination of two or more.

As the polyhydric alcohols having 3 or more hydroxy groups, a trihydric alcohol is preferred. Examples of the polyhydric alcohols having 3 or more hydroxy groups include glycerin, pentaerythritol, trimethylol propane, and sorbitol.

The alcohol component may further contain a monovalent aliphatic alcohol from the viewpoint of adjusting physical properties. Examples of the monovalent aliphatic alcohol include lauryl alcohol, myristyl alcohol, palmityl alcohol, and stearyl alcohol. These monovalent aliphatic alcohol may be used alone or in combination of two or more.

### (Carboxylic Acid Component)

Examples of the carboxylic acid component include aliphatic dicarboxylic acids, aromatic dicarboxylic acids, and trivalent or higher and hexavalent or lower polycarboxylic acids. These carboxylic acid components may be used alone or in combination of two or more.

As the aliphatic dicarboxylic acid, the carbon number of the main chain is preferably 4 or more, and preferably 10 or less, more preferably 8 or less, more preferably 6 or less, and the examples include fumaric acid, maleic acid, oxalic acid, malonic acid, citraconic acid, itaconic acid, glutaconic acid, succinic acid, adipic acid, suberic acid, azelaic acid, sebacic acid, dodecanedioic acid, succinic acid substituted with alkyl groups having a carbon number of 1 or more and 20 or less or alkenyl groups having a carbon number of 2 or more and 20 or less, or anhydrides thereof, and alkyl esters thereof (for example, 1 or more and 3 or less carbon number of alkyl groups). Examples of the substituted succinic acid include dodecylsuccinic acid, dodecenylsuccinic acid, and octenylsuccinic acid.

The succinic acid substituted with alkyl groups having a carbon number of 1 or more and 20 or less or alkenyl groups having a carbon number of 2 or more and 20 or less, or anhydrides thereof can be produced, for example, according to the description in JP2008-145712A. Moreover, commercially available products can also be used.

Examples of the aromatic dicarboxylic acid include phthalic acid, terephthalic acid, isophthalic acid, naphthalene dicarboxylic acid, anhydrides thereof, and alkyl esters thereof (for example, 1 or more and 3 or less carbon number of alkyl groups). Among the above aromatic dicarboxylic acids, isophthalic acid and terephthalic acid are preferred, and terephthalic acid is more preferred, from the viewpoint of suppressing aggregate scattering and water resistance.

The trivalent or higher and hexavalent or lower polycarboxylic acid is preferably a trivalent carboxylic acid. Examples of the trivalent or higher and hexavalent or lower polycarboxylic acid include trimellitic acid, 2,5,7-naphthalenetricarboxylic acid, pyromellitic acid, or acid anhydrides thereof.

The carboxylic acid component may further contain a monovalent aliphatic carboxylic acid from the viewpoint of adjusting physical properties. Examples of the monovalent aliphatic carboxylic acid include monovalent aliphatic carboxylic acids having a carbon number of 12 or more and 20 or less, such as lauric acid, myristic acid, palmitic acid, stearic acid, and alkyl (carbon number of 1 or more and 3 or less) esters of these acids. These monovalent aliphatic carboxylic acid may be used alone or in combination of two or more.

(Constituent Units Derived from Polyethylene Terephthalate)

The polyester resin may contain a constituent unit derived from ethylene glycol derived from polyethylene terephthalate and a constituent unit derived from terephthalic acid. Polyethylene terephthalate may contain small amounts of components such as butanediol and isophthalic acid in addition to constituent units derived from ethylene glycol and terephthalic acid. Polyethylene terephthalate is preferably a collected polyethylene terephthalate.

When the polyester resin contains a constituent unit containing ethylene glycol and terephthalic acid derived from polyethylene terephthalate, a “constituent unit derived from an alcohol component” includes a constituent unit derived from ethylene glycol derived from polyethylene terephthalate, and a “constituent unit derived from a carboxylic acid component” includes a constituent unit derived from terephthalic acid derived from polyethylene terephthalate.

### (Preferred Embodiment of Polyester Resin)

In the preferred embodiment of polyester resin, the content of terephthalic acid in 100 mol % of carboxylic acid component is preferably 20 mol % or more, more preferably 40 mol % or more, further more preferably 60 mol % or more, and preferably 100 mol % or less, from the viewpoint of ensuring compatibility with asphaltene in asphalt.

Further, in the preferred embodiment of polyester resin, the content of bisphenol A derivative in 100 mol % of alcohol component is preferably 10 mol % or more, more preferably 20 mol % or more, further more preferably 30 mol % or more, and preferably 100 mol % or less, from the viewpoint of further improving durability by interacting with asphaltene in asphalt.

The bisphenol A derivative is, for example, an alcohol component containing a structure represented by the following formula (i) or formula (ii).

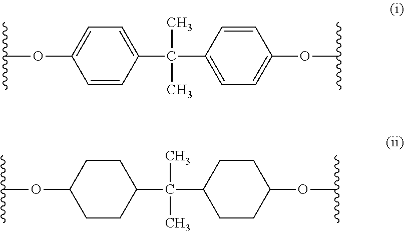 [SMILES: *Oc1ccc(C(C)(C)c2ccc(O*)cc2)cc1 ; *OC1CCC(C(C)(C)C2CCC(O*)CC2)CC1]

The phenylene group in the formula (i) and the cyclohexylene group in the formula (ii) may have a halogen atom, a substituent such as alkyl groups having a carbon number of 1 to 3. Examples of the halogen atom include a fluorine atom, a chlorine atom, a bromine atom, and an iodine atom. Examples of the alkyl group having a carbon number of 1 to 3 include a methyl group, an ethyl group, an n-propyl group, and an i-propyl group.

Examples of bisphenol A derivatives include bisphenol A, alkylene oxide adducts of bisphenol A, hydrogenated bisphenol A, and alkylene oxide adducts of hydrogenated bisphenol A. Among these, alkylene oxide adducts of bisphenol A and hydrogenated bisphenol A are preferred.

### (Physical Property of Polyester Resin)

From the viewpoint of durability and flexibility of asphalt pavement, the softening point of the polyester resin is preferably 80° C. or higher, more preferably 85° C. or higher, further more preferably 90° C. or higher, and preferably 140° C. or lower, more preferably 130° C. or lower, further more preferably 120° C. or lower, further more preferably 115° C. or lower.

From the same viewpoint, the weight-average molecular weight Mw of the polyester resin is preferably 5,000 or more, more preferably 7,000 or more, further more preferably 8,000 or more, and preferably 70,000 or less, more preferably 40,000 or less, and further more preferably 25,000.

The acid value of the polyester is preferably 1 mgKOH/g or more, more preferably 3 mgKOH/g or more, further more preferably 5 mgKOH/g or more, from the viewpoint of durability and flexibility of the asphalt pavement, and from the viewpoint of increasing the water resistance of the pavement surface, it is preferably 60 mgKOH/g or less, more preferably 30 mgKOH/g or less, and further more preferably 10 mgKOH/g or less.

The hydroxyl value of the polyester is preferably 1 mgKOH/g or more, more preferably 10 mgKOH/g or more, further more preferably 20 mgKOH/g or more, from the viewpoint of durability and flexibility of the asphalt pavement, and it is preferably 50 mgKOH/g or less, more preferably 45 mgKOH/g or less, and further more preferably 40 mgKOH/g or less.

The softening point, weight-average molecular weight Mw, acid value, and hydroxyl value of the polyester resin can be measured by the methods described in Examples. Note that the softening point, weight-average molecular weight Mw, acid value, and hydroxyl value can be adjusted by the raw material monomer composition, molecular weight, catalyst amount, or reaction conditions.

The polyester resin may be a polyester resin modified to the extent that the properties are not substantially impaired. Specifically, examples of the modified polyester resin include polyester resins which are grafted or blocked with phenol, urethane, epoxy, etc. by the method described in JPH11-133668A, JPH10-239903A, JPH8-20636, etc. Examples of the preferred modified polyester resin include urethane-modified polyester resins obtained by urethane-elongation of a polyester resin with polyisocyanate compound.

### (Content of Polyester Resin)

From the viewpoint of improving durability, the content of the polyester resin is preferably 1.5 parts by mass or more, more preferably 2.5 parts by mass or more, and further more preferably 5 parts by mass or more, relative to 100 parts by mass of asphalt, and from the viewpoint of maintaining flexibility, it is preferably 20 parts by mass or less, more preferably 15 parts by mass or less, further more preferably 10 parts by mass or less, further more preferably 8 parts by mass or less.

### (Manufacturing Method of Polyester Resin)

As the method for producing polyester resin contained in the modified asphalt composition of the present invention, for example, it can be produced by polycondensation of the above-mentioned alcohol component and carboxylic acid component.

From the viewpoint of adjusting reactivity, and durability and flexibility of asphalt pavement, the temperature of the polycondensation reaction is preferably 160° C. or higher, more preferably 190° C. or higher, further more preferably 200° C. or higher, and preferably 260° C. or lower, more preferably 250° C. or lower, further more preferably 240° C. or lower.

When the polyester resin used in the present invention contains a constituent unit derived from ethylene glycol derived from polyethylene terephthalate and a constituent unit derived from terephthalic acid derived from polyethylene terephthalate, the amount of polyethylene terephthalate in the raw material is, in the total amount of polyethylene terephthalate, the alcohol components, and the carboxylic acid components, preferably 5 mass % or more, more preferably 15 mass % or more, further more preferably 25 mass % or more, and preferably 80 mass % or less, more preferably 70 mass % or less, further more preferably 60 mass % or less.

By adding polyethylene terephthalate during the polycondensation reaction of the alcohol component and the carboxylic acid component, a transesterification reaction occurs, and a polyester resin in which the constituent unit of polyethylene terephthalate is incorporated into the constituent unit derived from the alcohol component and the constituent unit derived from the carboxylic acid component, can be obtained.

Polyethylene terephthalate may be present from the start of the polycondensation reaction, or may be added to the reaction system during the polycondensation reaction. From the viewpoint of durability and flexibility of the asphalt pavement, the adding timing of polyethylene terephthalate is at a stage when the reaction rate of the alcohol component and the carboxylic acid component is preferably 10% or less, more preferably 5% or less. Note that the reaction rate is a value of the amount of generated reaction water (mol)/the theoretical amount of generated water (mol)×100.

In the polycondensation reaction, an esterification catalyst can be used from the viewpoint of reaction rate. Examples of the esterification catalyst include tin (II) compounds having no Sn—C bond, such as tin (II) di(2-ethylhexanoate). From the viewpoint of reaction rate, the amount of the esterification catalyst to be used is preferably 0.01 parts by mass or more, more preferably 0.1 parts by mass or more, further more preferably 0.2 parts by mass or more, and preferably 1.5 parts by mass or less, more preferably 1.0 parts by mass or less, and further more preferably 0.6 parts by mass or less, relative to 100 parts by mass of the total amount of the alcohol component and the carboxylic acid component.

For the polycondensation reaction, promoters can be used in addition to the esterification catalyst. Examples of the promoter include pyrogallol compounds such as gallic acid. The amount of the promoter to be used is preferably 0.001 parts by mass or more, more preferably 0.005 parts by mass or more, further more preferably 0.01 parts by mass or more, and preferably 0.15 parts by mass or less, more preferably 0.10 parts by mass or less, and further more preferably 0.05 parts by mass or less, relative to 100 parts by mass of the total amount of the alcohol component and the carboxylic acid component.

### <Crosslinked Rubber>

The asphalt composition of the present invention contains a crosslinked rubber.

The rubber type of the crosslinked rubber is not particularly limited, and may be either natural rubber or synthetic rubber, or a combination thereof.

Examples of the synthetic rubber include diene-based synthetic rubbers, specifically styrene-butadiene copolymer, polybutadiene, polyisoprene, styrene-isoprene copolymer, butadiene-isoprene copolymer, butadiene-styrene-isoprene copolymer, acrylonitrile-butadiene copolymer, chloroprene rubber, butyl rubber, and halogenated butyl rubber. Further, a part of them may have a branched structure by using a polyfunctional modifying agent such as tin tetrachloride. The diene synthetic rubber may be used alone or in combination of two or more.

The crosslinked rubber is a vulcanized rubber preferably crosslinked with sulfur, other sulfur-containing compounds, peroxides, and more preferably crosslinked with sulfur or other sulfur-containing compounds.

The crosslinked rubber is preferably derived from rubber products, especially from used rubber products. Examples of the rubber products include tires, and examples of the used rubber products include waste tires.

The examples of the tires include tires for automobiles, tires for industrial vehicles and construction vehicles, and among them, tires for passenger vehicles (PC), or tires for trucks and buses (TB) of tires for automobiles, or tires for construction vehicle tires (OR) of tires for industrial vehicles and construction vehicles are preferred, and tires for trucks and buses (TB) are more preferred.

The tires usually contain a rubber component; compounding agent components such as carbon black and sulfur; and structural material components.

The crosslinked rubber contained in the asphalt composition of the present invention is preferably a crosslinked rubber derived from a tire, from the viewpoint of exhibiting the reinforcing effect of carbon black.

From the viewpoint of durability, the crosslinked rubber is in the form of chips or powder, and more preferably in the form of powder. Further, when the crosslinked rubber is a crosslinked rubber which is derived from a tire, the crosslinked rubber is preferably obtained by grinding the tire.

When the crosslinked rubber is a powdered crosslinked rubber, from the viewpoint of durability, the particle diameter is preferably 10 μm or more, more preferably 50 μm or more, further more preferably 100 μm or more, and 20 mm or less, more preferably 10 mm or less, more preferably 5 mm or less, and further more preferably 3 mm or less.

The particle diameter of the powdered crosslinked rubber can be measured using a test sieve in accordance with JIS Z 8801:2019.

In this description, “particle diameter” and “particle size” can be used replaceable.

Examples of commercially available crosslinked rubber include powdered rubber (particle shapes #16, #30, #50, etc.) manufactured by SHINSEI-GOMU CO. LTD.

The crosslinked rubber is preferably dispersed in the asphalt composition, more preferably in solid state, in the asphalt composition.

### (Content of Crosslinked Rubber)

From the viewpoint of improving durability, the content of the crosslinked rubber is preferably 1 parts by mass or more, more preferably 2 parts by mass or more, and further more preferably 3 parts by mass or more, relative to 100 parts by mass of asphalt, and from the viewpoint of maintaining flexibility, it is preferably 20 parts by mass or less, more preferably 10 parts by mass or less, further more preferably 5 parts by mass or less. Note that the content of the crosslinked rubber also includes the weight of components other than rubber, such as carbon black, when waste tires etc., are used.

The mass ratio of the crosslinked rubber to the polyester resin in the asphalt composition [(polyester resin)/(crosslinked rubber)] is preferably 1/9 or more, more preferably 2/8 or more, further more preferably 3/7 or more, and preferably 9/1 or less, more preferably 7/3 or less, further more preferably 5/5 or less, from the viewpoint of achieving both durability and flexibility.

The asphalt composition of the present invention is a binder composition, and can be used for paving after, for example, adding an aggregate to the asphalt composition to form an asphalt mixture. That is, the asphalt composition of the present invention is suitable for paving, particularly suitable for road pavement.

Furthermore, in an asphalt mixture that can be produced by mixing a polyester resin and crosslinked rubber with a mixture containing an asphalt and an aggregate, the asphalt binder that constitutes the layer covering the aggregate is also the asphalt composition of the present invention.

### [Method for Producing Asphalt Composition]

The method for producing an asphalt composition of the present invention preferably contains a step of mixing an asphalt, the above-described polyester resin, and the above-described crosslinked rubber.

It is preferable that the above-described polyester resin and the above-described crosslinked rubber are added to asphalt in the same step. That is, it is preferable that the crosslinked rubber is not mixed into the asphalt in advance as a modifier for modified asphalt, but is added together with the polyester resin and dispersed in the asphalt.

Further, the asphalt composition can be produced by, for example, mixing a polyester resin and crosslinked rubber with a mixture containing an asphalt and an aggregate. The obtained mixture will be in a state in which the aggregate is covered with a layer of the asphalt composition.

The asphalt composition is obtained by heating and melting an asphalt, adding a polyester resin and a crosslinked rubber, and stirring and mixing the mixture in a commonly used mixer until each component is uniformly dispersed. Examples of the commonly used mixers include homomixers, dissolvers, paddle mixers, ribbon mixers, screw mixers, planetary mixers, vacuum countercurrent mixers, roll mills, and twin screw extruders.

From the viewpoint of uniformly dispersing the polyester resin and crosslinked rubber in the asphalt, the mixing temperature of an asphalt, a polyester resin and a crosslinked rubber is preferably 100° C. or higher, more preferably 130° C. or higher, further more preferably 160° C. or higher, still further more preferably is 170° C. or higher, and preferably 230° C. or lower, more preferably 210° C. or lower, further more preferably 200° C. or lower, still further more preferably 190° C. or lower.

Furthermore, the mixing time of the asphalt with the polyester resin and the crosslinked rubber is preferably 1 minute or more from the viewpoint of efficiently dispersing the polyester resin and the crosslinked rubber uniformly in the asphalt, and from the viewpoint of improving productivity, it is preferably 10 hours or less, more preferably 7 hours or less, further more preferably 5 hours or less, further more preferably 3 hours or less, and further more preferably 1 hour or less. From the viewpoint of further improving dispersibility, the above-described mixing time is more preferably 10 minutes or more, further preferably 0.5 hours or more, further more preferably 1.0 hour or more, and further more preferably 1.5 hours or more. From the viewpoint of further improving productivity, it is more preferably 10 minutes or less, and further more preferably 2 minutes or less.

### [Asphalt Mixture]

The asphalt mixture of the present invention contains the asphalt, an aggregate, the polyester resin, and the crosslinked rubber.

The total content of the polyester resin and the crosslinked rubber in the asphalt mixture is preferably 0.01 mass % or more, more preferably 0.05 mass % or more, further more preferably 0.10 mass % or more, further more preferably 0.15 mass % or more, and it is preferably 4 mass % or less, more preferably 3 mass % or less, further more preferably 2 mass % or less, and further more preferably 1 mass % or less.

The content of the asphalt in the asphalt mixture is preferably 2.5 mass % or more, more preferably 3 mass % or more, further more preferably 3.5 mass % or more, and further more preferably 4 mass % or more, and it is preferably 10 mass % or less, more preferably 9 mass % or less, further more preferably 8 mass % or less, and further more preferably 7 mass % or less.

In the asphalt mixture of the present invention, the total content of the polyester resin and the crosslinked rubber is, from the viewpoint of the durability of the asphalt pavement, preferably 1 part by mass or more, more preferably 3 parts by mass or more, further more preferably 5 parts by mass or more, and is preferably 30 parts by mass or less, more preferably 25 parts by mass or less, further more preferably 20 parts by mass or less, relative to 100 parts by mass of the asphalt.

### <Aggregate>

The aggregate may be selected, for example, from any of crushed stone, boulders, gravel, sand, recycled aggregate, ceramics, etc. As the aggregate, either coarse aggregate having a particle diameter of 2.36 mm or more or fine aggregate having a particle diameter of less than 2.36 mm can be used.

Examples of the coarse aggregate include crushed stone having a particle diameter range of 2.36 mm or more and less than 4.75 mm, crushed stone having a particle diameter range of 4.75 mm or more and less than 12.5 mm, crushed stone having a particle diameter range of 12.5 mm or more and less than 19 mm, and crushed stone having a particle diameter range of 19 mm or more and less than 31.5 mm.

The fine aggregate preferably has a particle diameter of 0.075 mm or more and less than 2.36 mm. Examples of the fine aggregate include river sand, dune sand, mountain sand, sea sand, crushed sand, fine sand, screenings, crushed stone dust, silica sand, artificial sand, glass cullet, foundry sand, and recycled crushed aggregate sand.

The above particle diameter is the value specified in JIS A5001:2008.

Among these, a combination of coarse aggregate and fine aggregate is preferred.

The aggregate may further contain a filler having a particle diameter of less than 0.075 mm. Examples of the filler include sand, fly ash, calcium carbonate powder such as limestone powder, and hydrated lime. Among these, calcium carbonate powder is preferred from the viewpoint of improving the strength of asphalt pavement.

From the viewpoint of improving the strength of the asphalt pavement, the average particle diameter of the filler is preferably 0.001 mm or more, and preferably 0.05 mm or less, more preferably 0.03 mm or less, and further more preferably 0.02 mm or less.

Here, the average particle diameter means the average particle diameter at 50% cumulative volume (D50), and can be measured by a laser diffraction particle size analyzer.

From the viewpoint of the durability of the asphalt pavement, the mass ratio of the coarse aggregate to the fine aggregate is preferably 10/90 or more, more preferably 15/85 or more, further more preferably 20/80 or more, and is preferably 90/10 or less, more preferably 80/20 or less, further more preferably 70/30 or less.

Suitable examples of formulation in the asphalt mixtures include the following (1) to (3). (1) A fine-grained asphalt containing 30% by volume or more and less than 45% by volume of coarse aggregate, 30% by volume or more and 50% by volume or less of fine aggregate, and 5% by volume or more and 10% by volume or less of an asphalt composition. (2) As an example of the asphalt mixture, a dense grade asphalt containing, for example, 45% by volume or more and less than 70% by volume of coarse aggregate, 20% by volume or more and 45% by volume or less of fine aggregate, and 3% by volume or more and 10% by volume or less of an asphalt composition. (3) A porous asphalt containing 70% by volume or more and 80% by volume or less of coarse aggregate, 10% by volume or more and 20% by volume or less of fine aggregate, and 3% by volume or more and 10% by volume or less of an asphalt composition.

It is to be noted that the blending ratio of asphalt in the conventional asphalt compositions containing an aggregate and the asphalt may be in general determined by referring to an optimum asphalt amount obtained from “Formulation and Design of Asphalt Mixture” as described in “Guideline for Pavement Design and Construction” published by Japan Road Association.

In the present invention, the above-described optimum asphalt amount corresponds to the total amount of the asphalt, the polyester resin, and the crosslinked rubber. However, the method is not particularly limited to the method as described in “Guideline for Pavement Design and Construction”, and it may be acceptable to determine by any other methods.

Examples of the asphalt mixture of the present invention include, as one embodiment, a state in which aggregate is covered with a layer of the asphalt composition of the present invention.

### [Method for Producing Asphalt Mixture]

A method for producing an asphalt mixture of the present invention contains a step of mixing an asphalt, a heated aggregate, a polyester resin, and a crosslinked rubber.

In the step of mixing, the asphalt, the heated aggregate, the polyester resin, and the crosslinked rubber can be mixed simultaneously or in any order. From the viewpoint of durability and flexibility of the asphalt pavement, it is preferable to mix the crosslinked rubber with the heated aggregate simultaneously with or after the asphalt.

It is preferable that the above-described polyester resin and the above-described crosslinked rubber are added to asphalt in the same step. That is, it is preferable that the crosslinked rubber is not mixed into the asphalt in advance as a modifier for modified asphalt, but is added together with the polyester resin and dispersed in the asphalt.

Examples of the specific method for producing asphalt mixtures include manufacturing methods of the asphalt mixture such as conventional plant mix method and the premix method. Both methods are the method in which an asphalt (and a thermoplastic elastomer, if necessary), a polyester resin, and a crosslinked rubber are added to a heated aggregate. Examples of the method of addition include a premix method in which the asphalt (and a thermoplastic elastomer as necessary), the polyester resin, and the crosslinked rubber are dissolved in advance, and a plant mix method in which the asphalt (and a thermoplastic elastomer as necessary) is added to the aggregate, and then the polyester resin and the crosslinked rubber are added simultaneously or in any order. Among these, the plant mix method is preferred from the viewpoint of exhibiting asphalt performance.

More specifically, a method for producing an asphalt mixture preferably contains, in the mixing step,
(i) adding and mixing an asphalt (and a thermoplastic elastomer, if necessary) to a heated aggregate to obtain a mixture, then adding the polyester resin and crosslinked rubber, and mixing the mixture with a polyester resin and the crosslinked rubber;
(ii) adding and mixing an asphalt (and thermoplastic elastomer, if necessary), a polyester resin, and a crosslinked rubber simultaneously to a heated aggregate; or
(iii) adding and mixing a mixture of an asphalt (and a thermoplastic elastomer, if necessary) which is heated in advance, a polyester resin, and a crosslinked rubber to a heated aggregate.

Among these, from the viewpoint of efficiently dispersing the asphalt component, the mixing step is preferably the method (i) in which after an asphalt and a heated aggregate are mixed, a polyester resin and a crosslinked rubber are mixed.

In the above methods (i) to (iii), the method for preparing a mixture of asphalt (and a thermoplastic elastomer, if necessary), polyester resin, and the crosslinked rubber is not particularly limited, however it preferably contains a step of heating and melting an asphalt, adding a polyester resin, a crosslinked rubber, and other additives if necessary, and stirring and mixing in a commonly used mixer until the components are uniformly dispersed. Examples of the commonly used mixers include homomixers, dissolvers, paddle mixers, ribbon mixers, screw mixers, planetary mixers, vacuum countercurrent mixers, roll mills, and twin screw extruders.

The mixing temperature of the asphalt, the polyester resin, and the crosslinked rubber is, from the viewpoint of uniformly dispersing the polyester resin in the asphalt and exhibiting asphalt performance, preferably 100° C. or higher, more preferably 130° C. or higher, further more preferably 160° C. or higher, further more preferably 170° C. or higher, and preferably 230° C. or less, more preferably 210° C. or less, further more preferably 200° C. or less, further more preferably 190° C. or less.

The mixing time of the asphalt, the polyester resin, and the crosslinked rubber is, from the viewpoint of efficiently dispersing the polyester resin and the crosslinked rubber uniformly in the asphalt and exhibiting asphalt performance, preferably 0.1 hours or more, more preferably 0.5 hours or more, further more preferably 1.0 hours or more, further more preferably 1.5 hours or more, and preferably 10 hours or less, more preferably 7 hours or less, further more preferably 5 hours or less, further more preferably 3 hours or less.

The preferred contents of the polyester resin and the crosslinked rubber relative to the asphalt are as described above.

The asphalt mixture of the present invention is preferably used as a heated asphalt mixture which does not substantially contain water.

### [Construction Method of Road Pavement]

The asphalt mixture of the present invention is suitable for road pavement. The construction method of road pavement of the present invention preferably contains a step of constructing the asphalt mixture of the present invention to a road etc., and forming an asphalt pavement material layer. The asphalt pavement material layer is usually a base layer or a surface layer of a road, and from the viewpoint of exhibiting the effect of rutting resistance, it is preferably a surface layer of a road.

In the road pavement method, the asphalt mixture may be compacted and constructed using the same construction machinery organization and same method with the usual asphalt mixtures. The compaction temperature of the mixture when used as a heated asphalt mixture is, from the viewpoint of exhibiting the asphalt performance, preferably 100° C. or higher, more preferably 120° C. or higher, further more preferably 130° C. or higher, and preferably 200° C. or lower, more preferably 180° C. or lower, further more preferably 170° C. or lower.

### EXAMPLES

Various physical properties were measured and evaluated by the following methods.

Note that in the following Examples and Comparative Examples, part and % are based on mass unless otherwise indicated.

### (1) Softening Point of Polyester Resin

Using a flow tester “CFT-500D” (manufactured by Shimadzu Corporation), while 1 g of the sample was heated at a heating rate of 6° C./min, a load of 1.96 MPa was applied to the sample with a plunger, and the sample was extruded from a nozzle with a diameter of 1 mm and a length of 1 mm. The amount of plunger drop of the flow tester was plotted against the temperature, and the temperature at which half of the sample flowed out was determined as the softening point.

### (2) Molecular Weight of Polyester

The weight-average molecular weight was determined by gel permeation chromatography (GPC) according to the following method.

### (i) Preparation of Sample Solution

The sample was dissolved in chloroform at 40° C. to a concentration of 0.5 g/100 mL. Next, this solution was filtered using a PTFE type membrane filter “DISMIC-25JP” (manufactured by Toyo Roshi Kaisha, Ltd.) having a pore size of 0.20 μm to remove insoluble components, to obtain a sample solution.

### (ii) Molecular Weight Measurement

Chloroform was flowed as an eluent at a flow rate of 1 mL per minute, using the following measuring device and an analytical column, and the column was stabilized in a thermostatic bath at 40° C. 200 μL of the sample solution was injected therein and the measurement was performed. The molecular weight of the sample was calculated based on a calibration curve prepared in advance. For the calibration curve at this time, several types of monodisperse polystyrene (A-500 (5.0×10²), A-1000 (1.01× 10³), A-2500 (2.63× 10³), A-5000 (5.97×10³), F-1 (1.02×10⁴), F-2 (1.81× 10⁴), F-4 (3.97× 10⁴), F-10 (9.64× 10⁴), F-20 (1.90× 10⁵), F-40 (4.27×10⁵), F-80 (7.06× 10⁵), F-128 (1.09× 10⁶) manufactured by Tosoh Corporation) which were prepared as standard samples, were used. The molecular weights are indicated in parentheses.

Measuring device: “HLC-8320GPC” (manufactured by Tosoh Corporation)

Analytical column: “TSKgel Super HZM”+ “TSKgel Super H-RC”×2 (manufactured by Tosoh Corporation)

### (3) Acid Value and Hydroxyl Value of Polyester

The acid value and the hydroxyl value of the polyester were measured according to the method of JIS K0070:1992. However, the measurement solvent was changed from the mixed solvent of ethanol and ether specified in JIS K0070:1992 to a mixed solvent of acetone and toluene (acetone:toluene=1:1 (volume ratio)).

### Production Example 1 (Polyester Resin A-1)

The raw materials other than alkenyl succinic anhydride shown in Table 1 were placed in a 10-liter four-neck flask equipped with a thermometer, a stainless steel stirring rod, a downflow condenser, and a nitrogen inlet tube, and the amount of tin (II) di(2-ethylhexanoate) shown in Table 1 was added in a nitrogen atmosphere, and heated to 235° C. over 3 hours in a mantle heater, and maintained for 5 hours after reaching 235° C., and cooled to 180° C. after visually confirming that the PET particles had disappeared from the reaction product. After cooling to 180° C., alkenyl succinic anhydride (molecular weight=256) was added, the temperature was raised to 210° C. over 2 hours, and maintained at 210° C. for 1 hour, and the reaction was performed until the softening point reached 105.2° C. as shown in Table 1 after performing the reduced pressure reaction at 8.3 kPa, to obtain the target polyester resin A-1.

### Production Example 2 (Polyester Resin B-1)

The alcohol component of the polyester and terephthalic acid shown in Table 1 were placed in a 5-liter four-neck flask equipped with a thermometer, a stainless steel stirring rod, a downflow capacitor, and a nitrogen inlet tube, and the amount of tin (II) di(2-ethylhexanoate) shown in Table 1 was added in a nitrogen atmosphere, and heated to 235° C. over 3 hours in a mantle heater, and maintained for 7 hours after reaching 235° C. The reduced pressure reaction was performed at 8.0 kPa until the softening point reached 107.0° C. shown in the table, to obtain the target polyester resin B-1.

TABLE 1

| | | | Production Example | | | |
|---|---|---|---|---|---|---|
| | | | 1 | | 2 | |
| Type of polyester resin | | | A-1 | | B-1 | |
| Raw material | Monomer composition | | Preparation | Molar | Preparation | Molar |
| Monomer | | | amount (g) | ratio *1 | amount (g) | ratio *1 |
| | Alcohol | Ethylene glycol | | 60 | | |
| | component | BPA-EO *2 | | | 4875 | 75 |
| | | BPA-PO *3 | 5600 | 40 | 1750 | 25 |
| | Carboxylic | Terephthalic acid | 1660 | 85 | 2656 | 86 |
| | acid | Alkenyl succinic | 1072 | 10 | | |
| | component | anhydride | | | | |

| | | |
|---|---|---|
| PET | RAMAPET L1 *4 | 4608 |

| | | Preparation | Preparation |
|---|---|---|---|
| | | amount (g) | amount (g) |
| Esterification | tin(II) di(2-ethylhexanoate) | 64.7 | 47.4 |
| catalyst | | | |

| | | | |
|---|---|---|---|
| Physical | weight-average | 9845 | 7933 |
| properties | molecular weight | | |
| | Acid value | 7.3 | 2.1 |
| | Hydroxyl value | 29.1 | 37.9 |
| | Softening point (° C.) | 105.2 | 107.0 |

*1: Molar ratio of alcohol component and PET component relative to 100 mol of polyethylene glycol units However, the molar ratio of ethylene glycol includes the molar ratio of ethylene glycol units derived from the PET component, and the molar ratio of terephthalic acid includes the molar ratio of terephthalic acid units derived from the PET component.
*2: BPA-EO adduct: Polyoxyethylene (2.2 mol) adduct of bisphenol A
*3: BPA-PO adduct: Polyoxypropylene (2.2 mol) adduct of bisphenol A
*4: RAMAPET L1: Polyethylene terephthalate, manufactured by Indorama Ventures

### Example 1

15 kg of aggregate heated to 180° C. (see below for the composition of the aggregate) was placed in a mixer for asphalt and mixed at 180° C. for 60 seconds. Next, 820 g of straight asphalt (manufactured by Mitsubishi Corporation Energy Co., Ltd.) was added and mixed for 1 minute using the mixer for asphalt. Next, 41 g of polyester A1 and 41 g of crosslinked rubber 1 (powdered rubber #16, manufactured by SHINSEI-GOMU.) were added and mixed for 2 minutes in the mixer for asphalt. The obtained asphalt mixture is in a state in which the aggregate is covered with a layer of asphalt composition, and it was confirmed that there was no aggregation of the crosslinked rubber in visual observation of the asphalt composition and that the crosslinked rubber was dispersed in the asphalt in a solid state.

The obtained asphalt mixture was quickly filled into a 300×300×50 mm mold form and subjected to a rolling compaction treatment 25 times at a temperature of 150° C. and a load of 0.44 kPa using a roller compactor (manufactured by Iwata Kogyosho Co., Ltd.), and then heat-cured at 180° C. for 2 hours to prepare an asphalt test specimen. In addition, 1.2 kg of the asphalt mixture was weighed out and a cylindrical-shaped specimen was prepared using a Marshall test compactor (manufactured by Nakajima Technology Inc., “Automatic Asphalt Compaction Device”). The test specimens were slowly cooled to room temperature and demolded using a demolding machine.

### <Composition of Aggregate>

40.0 parts by mass of Crushed Stone #6
13.0 parts by mass of Crushed Stone #7
10.0 parts by mass of Crushed sand
22.0 parts by mass of river sand
10.0 parts by mass of mountain sand
5.0 parts by mass of Stone powder (calcium carbonate)

### Finer Mass %:

Sieve size 15 mm: 100 mass %
Sieve size 10 mm: 88.7 mass %
Sieve size 5 mm: 60.5 mass %
Sieve size 2.5 mm: 42.6 mass %
Sieve size 1.2 mm: 29.9 mass %
Sieve size 0.6 mm: 19.8 mass %
Sieve size 0.3 mm: 11.5 mass %
Sieve size 0.15 mm: 6.2 mass %

### [Evaluation]

### <Evaluation of the Amount of Rutting (Wheel Tracking Test)>

The obtained asphalt mixture was quickly filled into a 300×300×50 mm mold form and subjected to a rolling compaction treatment 25 times at a temperature of 150° C. and a load of 0.44 kPa using a roller compactor (manufactured by Iwata Kogyosho Co., Ltd.) after subjected to heat-curing at 180° C. for 2 hours, to prepare an asphalt test specimen M-la.

Asphalt specimen M-la was immersed in hot water set to 60° C. in a 60° C. constant temperature room, and a wheel tracking tester (manufactured by Iwata Kogyosho, load 1716N, iron wheel width 47 mm, linear pressure 291.5N/cm) was used to move the wheel back and forth on the specimen at a speed of 15 back and forth passes per minute, and the amount of displacement after 1,250 passing time of back and forth was measured. Other measurement conditions were in accordance with the “B003 Wheel Tracking Test” described in the “Hand book of Pavement investigation and examination method” published by the Japan Road Association.

The amount of rutting in the wheel tracking test is an indicator of the durability of asphalt pavement.

The results are shown in Table 2.

### <Measurement of Flow Value: Marshall Stability Test>

1.2 kg of the obtained asphalt mixture was weighed out and stored at 180° C. for 2 hours for thermal curing, and compacted using a Marshall test compactor “Automatic Asphalt Compaction Device” (manufactured by Nakajima Technology Inc.) 50 times on each side for a total of 100 times to prepare cylindrical-shaped asphalt specimens M-1b.

The demolded asphalt specimen M-1b was immersed in a constant temperature water tank at 60° C. for 30 minutes, and then the overturned asphalt specimen M-1b was crushed with a flat plate at a speed of 50 mm/min using a Marshall loading device (manufactured by Nakajima Technology Inc.), and the amount of displacement from the start of the displacement slope to the maximum load was measured and to be determined as the flow value. Other measurement conditions were in accordance with the “B001 Marshall Stability Test” described in the “Hand book of Pavement investigation and examination method” published by the Japan Road Association.

The flow value is used as an indicator of the flexibility and cracking resistance of asphalt pavement at operating temperatures.

The results are shown in Table 2.

### Examples 2 to 5, Comparative Examples 1 to 5

Except for changing the formulation of the asphalt mixture to that shown in Table 2, asphalt specimens were prepared in the same manner as in Example 1, and the amount of rutting and the flow value were evaluated.

The results are shown in Table 2.

The crosslinked rubbers used in Examples 1 to 5 and Comparative Examples 1 to 5 are shown below.

Crosslinked rubber 1: Powder rubber #16 (particle size under 1 mm), main material: TB tire, manufactured by SHINSEI-GOMU CO. LTD.

Crosslinked rubber 2: Powder rubber #30 (particle size under 500 μm), main material: TB tire, manufactured by SHINSEI-GOMU CO. LTD.

Crosslinked rubber 3: Powder rubber #50 (particle size under 300 μm), main material: TB tire, manufactured by SHINSEI-GOMU CO. LTD.

Note that the crosslinked rubbers 1 to 3 were all produced by grinding waste tires.

TABLE 2

| | | | | | | Pavement physical | |
|---|---|---|---|---|---|---|---|
| | | Polyester | | Crosslinked | | properties | |
| | | resin | | rubber | | Amount of | |
| | | | Content | | Content | rutting | Flow |
| | | Type | *1 | Type | *2 | [mm] | value |
| Examples | 1 | A-1 | 5 | Crosslinked | 5 | 2.8 | 3.2 |
| | | | | rubber 1 | | | |
| | 2 | A-1 | 7.5 | Crosslinked | 2.5 | 3 | 3.0 |
| | | | | rubber 1 | | | |
| | 3 | A-1 | 5 | Crosslinked | 5 | 4.3 | 3.3 |
| | | | | rubber 2 | | | |
| | 4 | A-1 | 5 | Crosslinked | 5 | 4.2 | 3.1 |
| | | | | rubber 3 | | | |
| | 5 | A-2 | 5 | Crosslinked | 5 | 5.1 | 2.9 |
| | | | | rubber 1 | | | |
| Com- | 1 | — | — | — | — | More | 2.5 |
| parative | | | | | | than 10 | |
| example | 2 | A-1 | 5 | — | — | 9.3 | 2.5 |
| | 3 | A-1 | 10 | — | — | 4.2 | 2.5 |
| | 4 | A-2 | 10 | — | — | 5.3 | 2.4 |
| | 5 | — | — | Crosslinked | 10 | 5.8 | 3.0 |
| | | | | rubber 1 | | | |

*1: Content of polyester (parts by mass) relative to 100 parts by mass of asphalt
*2: Content of crosslinked rubber (parts by mass) relative to 100 parts by mass of asphalt

From the results shown in Table 2, it is found that according to the present invention, an asphalt pavement having excellent durability and flexibility can be obtained.

1. An asphalt composition, comprising:
an asphalt,
a polyester resin having a softening point of 120° C. or lower, and
a crosslinked rubber.

2. The asphalt composition according to claim 1,
wherein [(crosslinked rubber)/(polyester resin)], which is a mass ratio of the crosslinked rubber to the polyester resin, is 1/9 or more and 9/1 or less.

3. The asphalt composition according to claim 1,
wherein the crosslinked rubber is a crosslinked rubber which is derived from a tire.

4. The asphalt composition according to claim 3,
wherein the crosslinked rubber derived from a tire is obtained by grinding the tire.

5. The asphalt composition according to claim 3,
wherein the tire is a waste tire.

6. The asphalt composition according to claim 1,
wherein a particle diameter of the crosslinked rubber is 20 mm or less.

7. The asphalt composition according to claim 1,
wherein the crosslinked rubber is dispersed in the asphalt.

8. The asphalt composition according to claim 1,
wherein the polyester resin contains a constituent unit derived from ethylene glycol derived from polyethylene terephthalate and a constituent unit derived from terephthalic acid.

9. The asphalt composition according to claim 1,
wherein the asphalt is a straight asphalt or a modified asphalt.

10. The asphalt composition according to claim 9,
wherein the asphalt is a modified asphalt, which is an asphalt modified by thermoplastic elastomer.

11. An asphalt mixture, comprising:
an asphalt,
a polyester resin having a softening point of 120° C. or lower,
a crosslinked rubber, and
an aggregate.

12. The asphalt mixture according to claim 11,
wherein a total content of the polyester resin and the crosslinked rubber in the asphalt mixture is 0.01 mass % or more and 4 mass % or less.

13. The asphalt mixture according to claim 11,
wherein a particle diameter of the crosslinked rubber is 20 mm or less.

14. The asphalt mixture according to claim 11,
wherein the polyester resin contains a constituent unit derived from ethylene glycol derived from polyethylene terephthalate and a constituent unit derived from terephthalic acid.

15. A method for producing an asphalt mixture, the method comprising:
mixing an asphalt, a polyester resin having a softening point of 120° C. or lower, a heated aggregate, and a crosslinked rubber.

16. The method according to claim 15,
wherein the mixing is performed by mixing the polyester resin and the crosslinked rubber after the asphalt and the heated aggregate are mixed.

17. The method according to claim 15,
wherein the polyester resin and the crosslinked rubber are added to the asphalt in the mixing.

18. A road pavement method comprising:
constructing the asphalt mixture according to claim 11, thereby forming an asphalt pavement material layer.

19. The asphalt composition according to claim 1,
wherein the polyester resin has a hydroxyl value of 10 mgKOH/g or more and 50 mgKOH/g or less.

20. The asphalt composition according to claim 1,
wherein the polyester resin comprises a constituent unit derived from an alcohol component and a constituent unit derived from a carboxylic acid component, and
the alcohol component contains 10 mol % or more of a bisphenol A derivative based on 100 mol % of the alcohol component.
